(19) United States
(12) Patent Application Publication
(10) Pub. No.: US 2016/0063855 A1
(43) Pub. Date: Mar. 3, 2016

(54) PORTABLE WIRELESS-CONTROLLED LOW FREQUENCY PULSE CONTROL SYSTEM

(71) Applicant: Chi-Pei WANG, Hsinchu City (TW)

(72) Inventor: Chi-Pei WANG, Hsinchu City (TW)

(21) Appl. No.: 14/830,193

(22) Filed: Aug. 19, 2015

(30) Foreign Application Priority Data
Aug. 26, 2014 (TW) 103129296

(51) Int. Cl. G08C 17/02; H04W 4/00

(52) U.S. Cl. CPC G08C 17/02; H04W 4/008

(57) ABSTRACT

A portable wireless-controlled low frequency pulse control system includes a computer unit, including display and control interface 11. A low frequency control software is loaded and executed in the computer unit. A low frequency pulser, is located outside the computer unit, including high-tension pulse circuit module, positive electrode and negative electrode and battery module. The high-tension pulse circuit module transmits high-tension electronic pulse to the positive and negative electrodes. A wireless signal connection interface is provided and is composed of a wireless signal transmitting unit located in the computer unit and a signal receiving unit located in the low frequency pulser. The peripheral low frequency pulser can be controlled by the computer unit wirelessly.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT Not applicable.

### REFERENCE TO AN APPENDIX SUBMITTED ON COMPACT DISC Not applicable.

### BACKGROUND OF THE INVENTION

1. Field of the Invention

The present invention relates generally to a low frequency pulse control system, and more particularly to a portable wireless-controlled innovative low frequency pulse control system type and technical disclosure.

2. Description of Related Art Including Information Disclosed Under 37 CFR 1.97 and 37 CFR 1.98.

Needle therapy is a part of our traditional medical treatment means. Chinese ancient medicine had known the coincidence relation between various acupoints and internal organs, so the acupuncture (e.g. acupuncturing auricle) had been used then to treat dozens of diseases. The present medicine has proved that the acupuncture is actually preventative for some diseases, for example, when the parotitis prevails, acupuncturing the parotid point and incretion point of auricle has good prevention effect; for the carsick and seasick persons, the carsickness and seasickness can be suppressed effectively by acupuncturing or embedding needles in the “subcortex”, “shenmen” and “occipital” points before taking a car or ship. These examples are merely a small part of acupuncture functions. It is obvious that the needle therapy is beneficial and functional to human health to some extent.

Based on the support and inspiration of the aforesaid theoretical basis of medicine, there have been some health-aiding products with acupuncture therapy effect (hereinafter referred to as acupuncture treatment instrument) developed using low frequency impulse stimulation principle on the market. The known structure of this kind of products usually comprises a special control host for acupuncture, generating low frequency and providing the control interface for starting/stopping and adjusting low frequency, and an extension wire with positive and negative electrodes, the extension wire is connected to the aforesaid control host. Therefore, in the application of said acupunture treatment instrument, said positive and negative electrodes contact the user's body, and then the control host adjusts the state of low frequency.

However, there is still room for perfecting the convenience in the practical application of the aforesaid known acupuncture treatment instrument products. It may because of considering the portability, the control host of the known acupuncture treatment instrument is usually provided with battery, as well as a high-tension electronic pulse circuit module, an electronic module, a control interface and so on, so that the control host must have certain volume and area. Such a volume can be carried with the user, but the users already have a smart phone or tablet PC, charger and so on with them. Therefore, the acupuncture treatment instrument is apparently redundant, heavy and inconvenient. How to make this type of electronic acupuncture product more convenient and smaller is actually a technical topic that shall be thought about by related circles.

Thus, to overcome said problems of the prior art, it would be an advancement in the art to provide an improved system that can significantly improve the efficacy.

Therefore, the inventor has provided the present invention of practicability after deliberate design and evaluation based on years of experience in the production, development and design of related products.

### BRIEF SUMMARY OF THE INVENTION

Said computer unit, low frequency pulser and wireless signal connection interface form the innovative unique structure and technical characteristic of the “portable wireless-controlled low frequency pulse control system” disclosed in the present invention, compared with (previous technology) proposed known structure, the present invention can use the display and control interface 11 of the computer unit to execute low frequency control software for control, and the high-tension electronic pulse output voltage and frequency states of positive and negative electrodes in the low frequency pulser are controlled by wireless transmission of wireless signal connection interface, so as to use the computer unit to control the peripheral low frequency pulser wirelessly. The structure and volume of the low frequency pulser are reduced, and the wireless control mode makes the devices more flexible, convenient and practically evolutionary.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is a schematic view of the preferred embodiment of the present invention.

FIG. 2 is a schematic view of the another embodiment of this structure.

FIG. 3 shows another embodiment of the low frequency pulser of the present invention.

### DETAILED DESCRIPTION OF THE INVENTION

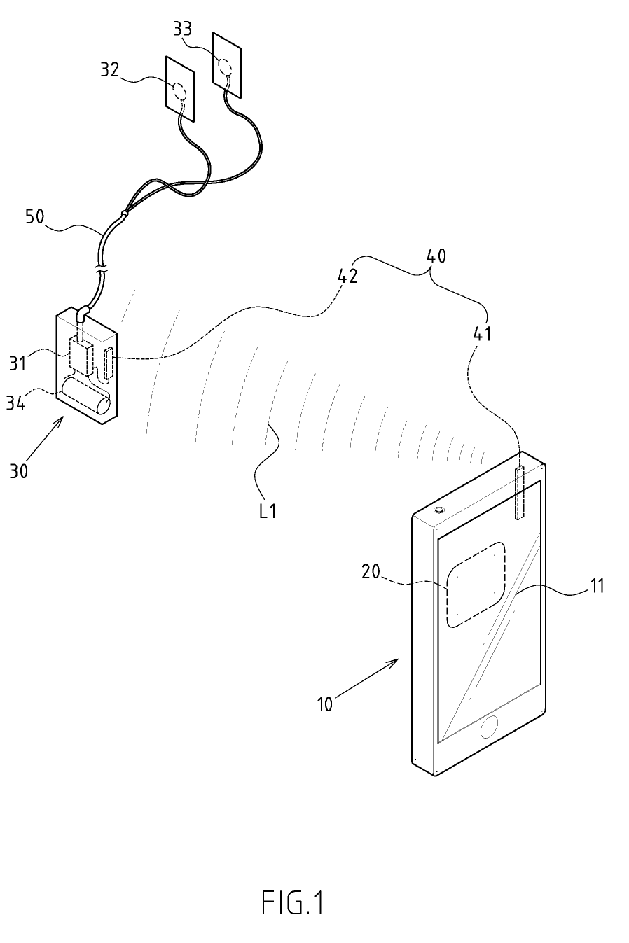

Referring to FIG. 1 for the preferred embodiment of the portable wireless-controlled low frequency pulse control system, but this embodiment is for illustration only, the patent application is not limited to this structure. Said portable wireless-controlled low frequency pulse control system comprises a computer unit 10, including a display and control interface 11; a low frequency control software 20, loaded and executed in computer unit 10; a low frequency pulser 30, located outside the computer unit 10. The low frequency pulser 30 comprises a high-tension pulse circuit module 31, at least a positive electrode 32 and a negative electrode 33, and a battery module 34 for supplying power for the operation of the low frequency pulser 30. The high-tension pulse circuit module 31 transmits high-tension electronic pulse to the positive and negative electrodes 32, 33; a wireless signal connection interface 40, including a wireless signal transmitting unit 41 located in the computer unit 10 and a signal receiving unit 42 located in the low frequency pulser 30. The signal receiving unit 42 is electrically connected to the high-tension pulse circuit module 31 to transmit control signal.

According to the aforesaid construction, as shown in FIG. 1, the low frequency control software 20 is executed in the display and control interface 11 of the computer unit 10 for control (i.e. the low frequency control software 20 generates a control and adjustment menu on the display and control interface 11), and the high-tension electronic pulse output voltage and frequency states of the positive and negative electrodes 32, 33 of the low frequency pulser 30 are controlled by wireless transmission of wireless signal connection interface 40 (as shown in L1), so as to use the computer unit 10 to control the peripheral low frequency pulser 30 wirelessly.

The computer unit 10 includes desktop computer, notebook computer, tablet PC and smart phone (as shown in FIG. 1).

The wireless signal connection interface 40 comprises Wireless Universal Serial Bus (Wireless USB), BLUETOOTH, Wi-Fi, 2.4 GHz radio.

The wireless signal transmitting unit 41 located in the computer unit 10 can be embedded in the computer unit 10 (as shown in FIG. 1) or external (not drawn); if it is said external type, the wireless signal transmitting unit 41 can be plugged into the USB or Audio of the computer unit 10.

As shown in FIG. 1, the low frequency pulser 30 has an extension wire 50 connecting the high-tension pulse circuit module 31 and the positive and negative electrodes 32, 33, so that the high-tension electronic pulse exported from the high-tension pulse circuit module 31 is transmitted via the extension wire 50 to the positive and negative electrodes 32, 33, and the positive and negative electrodes 32, 33 can be extended to the space outside the low frequency pulser 30 with the extension wire 50.

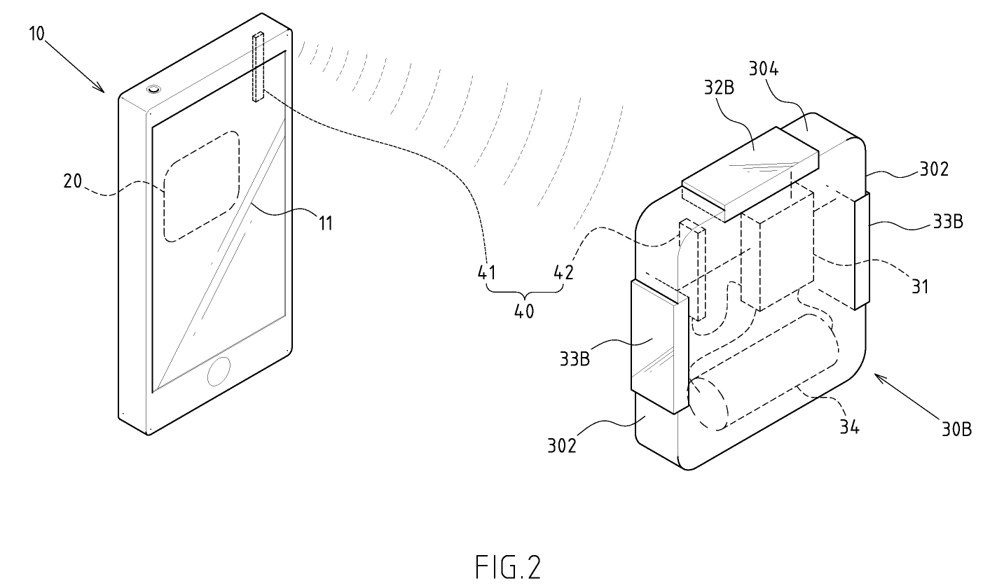

As shown in FIG. 2, the low frequency pulser 30B comprises side 302 and end 304, the negative electrode 33B is located in the side 302 for contacting the user's skin The positive electrode 32B is located in the end 304, the positive and negative electrodes 32B, 33B conducting state is formed when the user holds the negative electrode 33B in the side 302, the positive electrode 32B in the end 304 stimulates the user's acupoints to promote health.

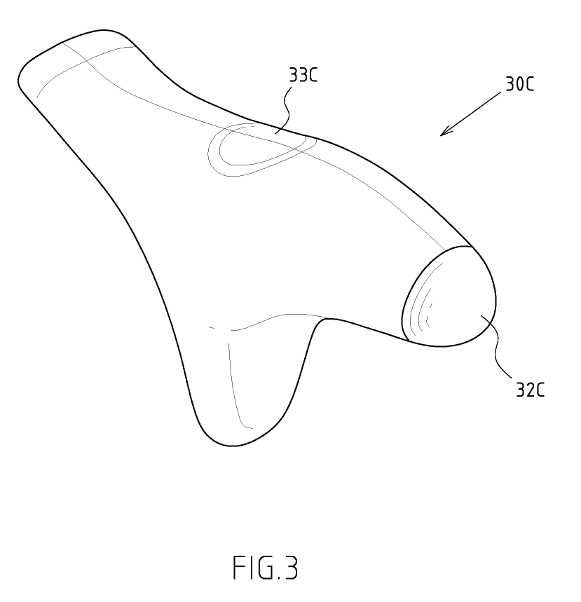

According to said structure type, the specific implementation type of the low frequency pulser 30 can be the general rectangular shape disclosed in FIG. 2, or the three-dimensional trident appearance of low frequency pulser 30C disclosed in FIG. 3, the positive electrode 32C and negative electrode 33C can be located in the end of a prong and the intermediate zone of top side respectively.

Based on this design, the user holds the negative electrode 33C on the top side in operation, and then the positive electrode 32C in the end of a prong stimulates the user's acupoints to promote health.

Where the specific implementation type of positive electrode 32 and negative electrode 33 of the low frequency pulser 30 can be but are not limited to patch (as shown in FIG. 1), metal rod, holder and so on.

I claim:

1. A portable wireless-controlled low frequency pulse control system comprises:
a computer unit, including a display and control interface;
a low frequency control software, loaded and executed in computer unit;
a low frequency pulser, located outside the computer unit; the low frequency pulser comprises a high-tension pulse circuit module, at least a positive electrode and a negative electrode, a battery module supplying power for the operation of the low frequency pulser; the high-tension pulse circuit module transmits high-tension electronic pulse to the positive and negative electrodes;
a wireless signal connection interface, composed of a wireless signal transmitting unit located in the computer unit and a signal receiving unit located in the low frequency pulser; the signal receiving unit is electrically connected to the high-tension pulse circuit module;
therefore, the display and control interface 11 of the computer unit executes the low frequency control software for control, and the high-tension electronic pulse output voltage and frequency states of the positive and negative electrodes in the low frequency pulser are controlled by wireless transmission of the wireless signal connection interface, so as to use the computer unit to control the peripheral low frequency pulser wirelessly.

2. The system defined in claim 1, wherein the computer unit includes desktop computer, notebook computer, tablet PC and smart phone.

3. The system defined in claim 2, wherein the wireless signal connection interface comprises Wireless Universal Serial Bus (Wireless USB), BLUETOOTH, Wi-Fi and 2.4 GHz radio.

4. The system defined in claim 3, wherein the wireless signal transmitting unit located in the computer unit is embedded in the computer unit or external; if it is said external type, the wireless signal transmitting unit is plugged into the USB or Audio of the computer unit.

5. The system defined in claim 4, wherein the low frequency pulser has an extension wire connecting the high-tension pulse circuit module and the positive and negative electrodes, so that the high-tension electronic pulse exported from the high-tension pulse circuit module is transmitted via the extension wire to the positive and negative electrodes, and the positive and negative electrodes can be extended to the space outside the low frequency pulser with the extension wire.

6. The system defined in claim 4, wherein the low frequency pulser has side and end, the negative electrode is located in the side to contact the user's skin, the positive electrode is located in the end, the positive and negative electrodes conducting state is formed when the user holds the negative electrode in the side, then the positive electrode in the end stimulates the user's acupoints to promote health.
